(19) United States
(12) Patent Application Publication
(10) Pub. No.: US 2026/0246289 A1
(43) Pub. Date: Aug. 20, 2026

(54) Open-loop control and closed-loop control of a system using a digital twin of a rechargeable battery

(71) Applicant: Hilti Aktiengesellschaft, Schaan (LI)

(72) Inventors: Varnim GOYAL, Landsberg am Lech (DE); Stefan MAYER, Fensterbach (DE); Bilal Riasat ALI, Landsberg am Lech (DE)

(21) Appl. No.: 18/869,689

(22) PCT Filed: Jun. 14, 2023
(86) PCT No.: PCT/EP2023/065897

§ 371 Date: Nov. 26, 2024

(30) Foreign Application Priority Data
Jun. 28, 2022 (EP) 22181512.9

(51) Int. Cl. H02J 7/80; B25F 5/02

(52) U.S. Cl. CPC H02J 7/80; B25F 5/02

(57) ABSTRACT

A method for controlling and regulating a system containing at least one accumulator as a first system component having at least one energy storage cell, at least one first transceiver, and at least one sensor for detecting at least one characteristic value and a second system component having at least one second transceiver. Comprising the method steps: detecting at least one first and second characteristic value by way of the at least one sensor; emitting the detected characteristic values by way of the at least first transceiver to a computing device having a digital twin of the at least one accumulator; and ascertaining a threshold value for at least one parameter of the accumulator by feeding the detected characteristic values into the digital twin to simulate a future behavior and/or profile of at least one parameter. System for carrying out the method. Charging device for carrying out the method.

The present invention relates to a method for controlling and regulating a system containing at least one accumulator as a first system component having at least one energy storage cell, at least one first transceiver, and at least one sensor for detecting at least one characteristic value and a second component having at least one second transceiver.

Furthermore, the present invention relates to a system containing an accumulator and a second system component, which is releasably connectable to the accumulator, for carrying out the method.

In addition, the present invention relates to a charging device for carrying out the method.

### BACKGROUND

Power tools which are supplied with electrical energy from an accumulator are very well known from the prior art. For this purpose, the accumulator essentially contains a multiplicity of energy storage cells (also called accumulator cells) positioned in a solid housing. By means of the energy storage cells, electrical energy can be stored by the accumulator and also provided for a power tool.

On one side of the housing of the accumulator, provision is made here for an interface by way of which the accumulator can be releasably connected either to a power tool or to a charging device. In order to charge an accumulator with electrical energy, the accumulator is releasably connected to the charging device. According to the prior art, the charging devices have an interface on one side of the housing of the charging device, by way of which interface the accumulator is mechanically and electrically connected to the charging device.

Modern accumulators can be used in a versatile or nearly universal manner as an energy source with greatly varying power tools or similar devices, such as vacuum cleaners, lamps, measuring devices, or the like.

### SUMMARY OF THE INVENTION

The specific load or strain of the accumulator can be entirely different in this case depending on the use of an accumulator as an energy source on a specific device.

It is thus possible, for example, that an accumulator as an energy source for a high performance power tool (such as a battery-operated chisel hammer) has to provide a relatively large amount of energy (i.e., a high amperage) for a relatively short time (i.e., a few seconds). However, an accumulator which is used as an energy source for a (construction site) light has to provide less energy (i.e., a low amperage) for a longer period of time (i.e., several minutes).

In addition, depending on the area of use of the respective accumulator as an energy source, the number of the charge cycles, the charging duration, the energy absorbed or emitted by the accumulator, the mechanical or thermal strain, etc., can be entirely different.

Possible damage, individual malfunctions, or also a complete failure of an accumulator are therefore to be attributed to very different reasons. An extensive analysis of the respective affected accumulator is often necessary for this purpose.

It is an object of the present invention to solve the problem described above.

The present invention provides a method for controlling and regulating a system containing at least one accumulator as a first system component having at least one energy storage cell, at least one first transceiver, and at least one sensor for detecting at least one characteristic value and a second system component having at least one second transceiver.

According to the invention, the following method steps are provided:
detecting at least one first and second characteristic value by way of the at least one sensor;
emitting the detected characteristic values by way of the at least one first transceiver to a computing device having a digital twin of the at least one accumulator; and
ascertaining a threshold value for at least one parameter of the accumulator by feeding the detected characteristic values into the digital twin to simulate a future behavior and/or profile of at least one parameter.

According to an alternative embodiment, it can be possible that the detection of the second characteristic value takes place after passage of a predetermined duration from the detection of the first characteristic value. The duration can be several seconds or several minutes, in particular 10 seconds to 10 minutes.

According to an alternative embodiment, it can be possible that setting the at least one accumulator from a first operating state into a second operating state is included if at least one parameter of the accumulator reaches a predetermined threshold value or if at least one parameter of the accumulator reaches the ascertained threshold value.

According to an alternative embodiment, it can be possible that emitting at least one signal from the charging device to the accumulator is included if at least one parameter of the accumulator reaches a predetermined threshold value or if at least one parameter of the accumulator reaches the ascertained threshold value.

The present invention also provides a system including an accumulator and a second system component, which is releasably connectable to the accumulator, for carrying out the method.

It is provided according to the invention that the at least one accumulator includes at least one first transceiver and at least one sensor for detecting at least one characteristic value and the second system component includes at least one second transceiver, and a computing device having a digital twin of the at least one accumulator is included.

According to an alternative embodiment, it can be possible that the computing device having the digital twin of the at least one accumulator is a component part of the second system component.

According to an alternative embodiment, it can be possible that the computing device having the digital twin of the at least one accumulator is designed as a separate system component.

According to an alternative embodiment, it can be possible that the second system component is designed as a charging device or power tool.

The present invention also provides a charging device for carrying out the method according to the invention.

It is provided according to the invention that the charging device includes at least one second transceiver and a computing device having a digital twin of at least one accumulator.

### BRIEF DESCRIPTION OF THE DRAWINGS

Further advantages will become apparent from the following description of the figures. Various exemplary embodiments of the present invention are illustrated in the figures.

The figures, the description, and the claims contain numerous features in combination. A person skilled in the art will expediently also consider the features individually and combine them to produce useful further combinations.

In the figures:

FIG. 1 shows a schematic side view of a power tool according to a first embodiment and an accumulator, connected to the power tool, according to a first embodiment; and

FIG. 2 shows a schematic side view of the charging device according to a first embodiment and an accumulator, connected to the power tool, according to a second embodiment.

### DETAILED DESCRIPTION

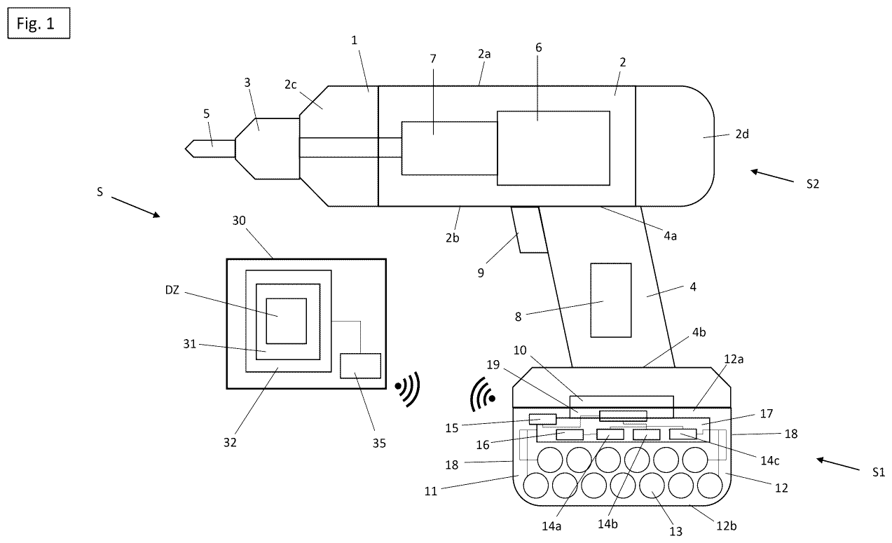

FIG. 1 shows a power tool 1 and an accumulator 11 according to an exemplary embodiment. The power tool 1 and the accumulator 11 form a system S according to a first embodiment.

The power tool 1 is designed in the form of a screwdriver in the embodiment shown. Alternatively, the power tool 1 can also be designed in the form of a power drill, a hammer drill, a saw, a grinder, or the like.

As indicated in FIG. 1, the power tool 1 in the form of a screwdriver substantially includes a power tool housing 2 having a toolholder 3 and a handle 4. The toolholder 3 is used to receive and hold a tool 5. The tool 5 is a screwdriver bit in the present example. Alternatively, the tool 5 may also be designed as a drill.

Provided in the interior of the power tool housing 2 is, inter alia, a drive 6, a transmission 7, and a control unit 8. The drive 6 is in this case in the form of a brushless electric motor.

The control unit 8 controls and regulates the functions and the behavior of the power tool 1 and in particular the drive 6.

The handle 4 in turn contains an actuating switch 9, an upper end 4a, and a lower end 4b. The actuating switch 9 is connected to the control unit 8, so that actuating the actuating switch 9 results in an activation of the drive 6 or the power tool 1. As also shown in FIG. 1, the drive 6, the transmission 7, and the toolholder 3 are arranged in relation to one another such that a torque generated in the drive 6 can be transmitted via the transmission 7 to the toolholder 3 and the tool 5.

The power tool housing 2 furthermore includes an upper side 2a, a lower side 2b, a front end 2c, and a rear end 2d. The toolholder 3 is positioned at the front end 2c. The upper end 4a of the handle 4 is fastened to the lower side 2b and in the vicinity of the rear end 2d of the power tool housing 2. A power tool interface 10 is positioned at the lower end 4b of the handle 4. The power tool interface 10 is used for releasably connecting the power tool 1 to the accumulator 11.

The accumulator 11 described in the exemplary embodiment can be used in particular as an energy storage device or electrical energy source for the power tool 1. The accumulator 11 here essentially includes an accumulator housing 12, a number of energy storage cells 13, a first, second, and third sensor 14a, 14b, 14c, a first transceiver 15, a storage device 16, and a control device 17. The energy storage cells 13 can also be referred to as accumulator cells.

The storage device 16 is positioned in the interior of the accumulator housing 12 and is used to store and provide data and information.

The sensors 14a, 14b, 14c are used in general for detecting characteristic values of the accumulator 11 or individual component parts of the accumulator 11. The characteristic value can also be designated as a parameter or characteristic variable. The characteristic values of the accumulator 11 can include, inter alia, voltage, amperage, electrical resistance, temperature, ambient humidity, or the like.

The first sensor 14a is a sensor for detecting an amperage value, which can also be designated as a current measuring device, current detecting device, current meter, or amp meter. The first sensor 14a is positioned here in the interior of the accumulator housing 12 so that the amperage values of the energy storage cells 13 can be detected. The first sensor 14a is connected to the storage device 16 and to the control device 17, so that the detected values can be stored and/or processed. More than one single sensor can be provided for detecting an amperage value, so that the amperage value of each energy storage cell 13 can be detected.

The second sensor 14b is a sensor for detecting a voltage value, which can also be designated as a voltage measuring device, voltage meter, or voltmeter. The second sensor 14b is positioned here in the interior of the accumulator housing 12 so that the voltage values of the energy storage cells 13 can be detected. The second sensor 14b is connected to the storage device 16 and to the control device 17 so that the detected values can be stored and/or processed. More than one single sensor can be provided for detecting a voltage value, so that the voltage value of each energy storage cell 13 can be detected.

The third sensor 14c is a sensor for detecting a temperature value, which can also be designated as a temperature detection device, temperature meter, or thermometer. The third sensor 14c is positioned here in the interior of the accumulator housing 12 so that the temperature values of the energy storage cells 13 can be detected. The third sensor 14c is connected to the storage device 16 and to the control device 17, so that the detected values can be stored and/or processed. More than one single sensor can be provided for detecting a temperature value, so that the temperature value of each energy storage cell 13 can be detected.

According to an alternative embodiment of the accumulator 11, more or fewer than three sensors 14a, 14b, 14c can also be provided.

The first transceiver 15 is used for emitting and receiving signals and data. The transceiver 15 may also be referred to as a transceiving device. In combination or interaction with a further transceiver, data and information can be sent from the accumulator 11 to another device or appliance and also received therefrom with the aid of the first transceiver 15. In the present exemplary embodiment, the first transceiver 15 is designed on the basis of Bluetooth technology. However, it is also possible that the transceiver 15 is based on another suitable wireless data transmission technology, such as WLAN, ZigBee, NFC, Wibree, or WiMAX in the radio frequency range. The first transceiver 15 can be a component part of the control device 17 of the accumulator 11 here. According to an alternative exemplary embodiment, the first transceiver 15 can also be designed on the basis of a wired data transmission technology.

The accumulator housing 12 in turn contains an upper side 12a, a lower side 12b, and four side walls 18. As is apparent in FIG. 1, an accumulator interface 19 is arranged on the upper side 12a of the accumulator housing 12. Both the energy storage cells 13 and the control device 17 are positioned in the interior of the accumulator housing 12. The control device 17 is used to control and regulate the functions and the behavior of the accumulator 11. The functions of the accumulator 11 include, inter alia, the quantitative absorption and emission of electrical energy to or from the energy storage cells 13. As also indicated in FIG. 1, the control device 17 is connected to the accumulator interface 19. Furthermore, the control device 17 is connected to the individual energy storage cells 13, so that electrical energy can pass from and to the energy storage cells 13. The accumulator interface 19 arranged on the upper side 12a of the accumulator housing 12 is used for releasably connecting the accumulator 11 to the power tool interface 10 of the power tool 1 so that, when the power tool 1 and the accumulator 11 are in a connected state, electrical energy can pass from the energy storage cells 13 of the accumulator 11 to the consumers (i.e., drive and control unit) of the power tool 1.

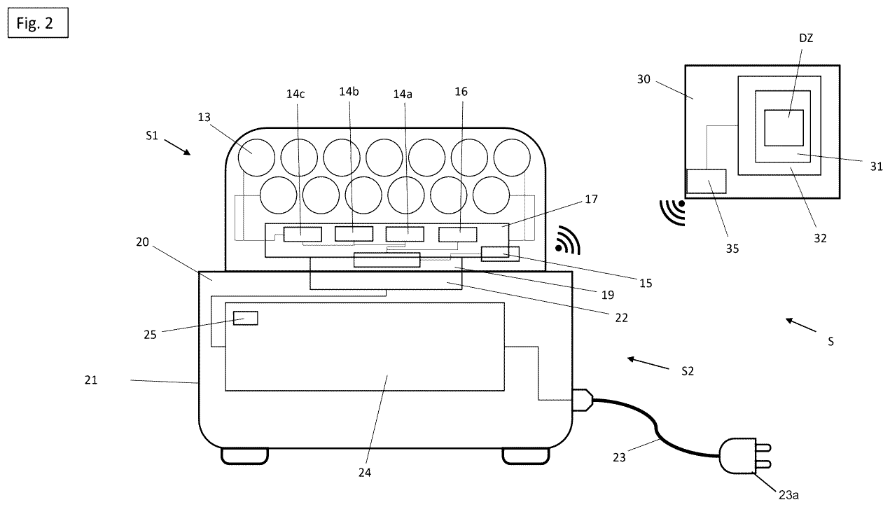

FIG. 2 shows a charging device 20 according to the invention according to an exemplary embodiment and the accumulator 11. The charging device 20 and the accumulator 11 form a system S according to a second embodiment.

The charging device 20 is used for charging an accumulator 11, which is connectable to the charging device 20, with electrical energy.

As also shown in FIG. 2, the charging device 20 contains a charger housing 21 having a charger interface 22 and a power cable 23. A control device 24 and a second transceiver 25 are positioned in the interior of the charger housing 21.

The power cable 23 includes a plug 23a, using which the charging device is releasably connectable to a grid power source.

The second transceiver 25 is used to emit and receive signals and data. In combination or interaction with the first transceiver 15, data and information can be exchanged between the charging device 20 and the accumulator 11 with the aid of the second transceiver 25. The first and second transceiver 15, 25 are designed in a manner corresponding thereto or in the form of a corresponding data transmission technology. In the present exemplary embodiment, the second transceiver 25 is also designed on the basis of Bluetooth technology. However, it is also possible that the transceiver 25 is based on another suitable wireless data transmission technology, such as WLAN, ZigBee, NFC, Wibree, or WiMAX in the radio frequency range. The second transceiver 25 can be a component part of the control device 24 of the charging device 20 here. According to an alternative exemplary embodiment, the second transceiver 25 can also be designed on the basis of a wired data transmission technology.

The method for controlling and regulating the system S according to the invention will be described hereinafter. According to a first exemplary embodiment, the system S includes a first and second system component S1, S2. The first system component S1 is designed in the form of the accumulator 11 and the second system component S2 is designed in the form of the charging device 20. Alternatively, the system can also contain more than two system components S1, S2. Furthermore, it is also possible that according to a further exemplary embodiment, the second system component S2 is designed as a power tool 1.

To carry out the method according to the invention for controlling and regulating the exemplary system S consisting of the charging device 20 and the accumulator 11, characteristic values of the accumulator 11 are detected with the aid of a sensor 14a, 14b, 14c. At least one first and second characteristic value KW1, KW2 of the accumulator 11 are detected here. The first sensor 14a therefore detects a first and second amperage value SSW1, SSW2 of the energy storage cells 13. The detected amperage values are transmitted from the sensor 14a, 14b, 14c to the first transceiver 15 of the accumulator 11. The first transceiver 15 subsequently transmits the detected amperage values to the second transceiver 15 of the charging device 20. The second transceiver 25 of the charging device 20 transmits the detected amperage values to a computing device 30. In a first exemplary embodiment, the computing device 30 is designed as an independent device. However, as described hereinafter, it is also possible according to a further exemplary embodiment that the computing device 30 is designed as a component part of the charging device 20, the accumulator 11, or the power tool 1.

The computing device 30 is used, inter alia, for receiving, storing, and processing data and information. The computing device 30 can also be designated as a computing machine, computer, data processing system, or the like, and essentially includes a storage device 31, a controller 32, and a third transceiver 35. The storage device 31 is used for storing and providing data and information.

According to the present exemplary embodiment, the storage device 31 includes a digital twin DZ of the accumulator 11. The digital twin is used in particular for simulating a future behavior and/or profile of at least one parameter of the accumulator 11.

In this context, a digital twin DZ is to be understood as a digital representation of the accumulator 11 in a digital environment. The digital twin DZ enables a comprehensive data exchange and is to be understood as more than solely a collection of data, rather it consists of a model or also multiple models of the represented accumulator 11. The digital twin DZ can include additional simulations, algorithms, functions, and services, which describe and influence properties or behavior of the represented accumulator 11, or offer services or functions in relation thereto.

With the aid of the algorithm stored in the controller 32 of the computing device 30, a threshold value is determined for a parameter of the accumulator 11. For this purpose, the detected and transmitted characteristic values of the accumulator 11 are fed into the digital twin DZ. Due to the use of the digital twin DZ, a future behavior or a future profile of the parameters for the accumulator 11 can then be simulated.

### LIST OF REFERENCE SIGNS

1 power tool
2 power tool housing
2a upper side of the power tool housing
2b lower side of the power tool housing
2c front end of the power tool housing
2d rear end of the power tool housing
3 toolholder
4 handle
4a upper end of the handle
4b lower end of the handle
5 tool
6 drive
7 transmission
8 control unit of the power tool
9 actuating switch
10 power tool interface
11 accumulator
12 accumulator housing
12a upper side of the accumulator housing
12b lower side of the accumulator housing
13 energy storage cell
14a first sensor
14b second sensor
14c third sensor
15 first transceiver
16 storage device
17 control device
18 side walls of the accumulator
19 accumulator interface
20 charging device
21 charger housing
22 charger interface
23 power cable
24 control device of the charging device
25 second transceiver
30 computing device
31 storage device of the computing device
32 controller of the computing device
35 third transceiver
S system
S1 first system component
S2 second system component
DZ digital twin
KW1 first characteristic value
KW2 second characteristic value

What is claimed is:

1-9. (canceled)

10. A method for controlling and regulating a system including at least one accumulator as a first system component having at least one energy storage cell, at least one first transceiver, and at least one sensor for detecting at least one characteristic value and a second system component having at least one second transceiver, the method comprising the steps of:
detecting at least one first and second characteristic value by way of the at least one sensor;
emitting the detected characteristic values by way of the at least one first transceiver to a computing device having a digital twin of the at least one accumulator; and
ascertaining a threshold value for at least one parameter of the accumulator by feeding the detected characteristic values into the digital twin to simulate a future behavior or profile of at least one parameter.

11. The method as recited in claim 10 wherein the detection of the second characteristic value takes place after passage of a predetermined duration from the detection of the first characteristic value.

12. The method as recited in claim 10 further comprising setting the at least one accumulator from a first operating state into a second operating state if the at least one parameter of the accumulator reaches a predetermined threshold value or if the at least one parameter of the accumulator reaches the ascertained threshold value.

13. The method as recited in claim 10 further comprising emitting at least one signal from the second system component to the accumulator if at least one parameter of the accumulator reaches a predetermined threshold value or if the at least one parameter of the accumulator reaches the ascertained threshold value.

14. A system comprising:
an accumulator; and
a second system component releasably connectable to the accumulator for carrying out the method as recited in claim 10 wherein the at least one accumulator includes at least one first transceiver and at least one sensor for detecting at least one characteristic value and the second system component includes at least one second transceiver and a computing device having a digital twin of the at least one accumulator.

15. The system as recited in claim 14 wherein the computing device having the digital twin of the at least one accumulator is a component part of the second system component.

16. The system as recited in claim 14 wherein the computing device having the digital twin of the at least one accumulator is a separate system component.

17. The system as recited in claim 14 wherein the second system component is designed as a charging device or a power tool.

18. A charging device for carrying out the method as recited in claim 10, the charging device comprising at least one second transceiver and the computing device having the digital twin of the at least one accumulator.
